(19) United States
(12) Patent Application Publication
(10) Pub. No.: US 2008/0290094 A1
(43) Pub. Date: Nov. 27, 2008

(54) FIRE RESISTANT CONTAINER FOR BATTERY-OPERATED ELECTRONIC DEVICES

(76) Inventor: William Bruce, Huntsville, OH (US)

Correspondence Address: MCNEES WALLACE & NURICK LLC, 100 PINE STREET, P.O. BOX 1166, HARRISBURG, PA, 17108-1166, US

(21) Appl. No.: 12/056,030

(22) Filed: Mar. 26, 2008

Related U.S. Application Data
(60) Provisional application No. 60/939,459, filed on May 22, 2007.

(51) Int. Cl. B65D 90/02; A62C 3/16; A62C 2/06

(52) U.S. Cl. 220/560.01; 169/54; 109/80

(57) ABSTRACT

A container for battery-operated electronics equipment is provided. This container, which is typically flexible, includes a body having an open end and at least one cavity formed therein, wherein the at least one cavity is adapted to receive electronics equipment; and at least one flap for covering the open end of the body, wherein the at least one flap is adjustable for accommodating electronics equipment of different types and sizes. The body and the at least one flap are manufactured from at least one fire-resistant material.

### CROSS-REFERENCE TO RELATED APPLICATIONS

This patent application claims the benefit of U.S. Provisional Patent Application Ser. No. 60/939,459 filed on May 22, 2007 and entitled “Fire Resistant Container for Batteries”, the disclosure of which is incorporated by reference as if fully rewritten herein.

### BACKGROUND OF THE INVENTION

Lithium batteries have revolutionized electronics. Capable of storing an enormous amount of energy in a relatively small package, the lithium-ion battery is perhaps the most popular power source for notebook computers, MP3 players, high-performance cellular phones, and other sophisticated electronic devices. The nickel-metal-hydride battery is the closest competitor for use in laptops and mobile phone markets; however, such batteries require more care to prolong battery life and they typically generate less power. The lithium-ion battery is known to hold a charge longer and has the capacity to produce ever-greater power as manufacturing technology advances. However, the fragile chemistry of the lithium-ion battery often utilizes circuitry to control peak voltage, and as technology enhancements produce models possessing more power, some of these batteries have overheated or even exploded under certain environmental conditions. Lithium batteries are typically of two types: lithium metal, which are single-use, and lithium-ion, which may be recharged. Both store energy that generates intense heat during a short circuit. A short can occur if metal touches both terminals or if internal seals fail. If the batteries short-circuit, they can produce intense heat, and most of the batteries contain flammable chemicals. The problem is termed “thermal runaway” and involves a chemical reaction inside a battery cell that generates intense heat so rapidly that it flares out of control. Most of the failures are traced to a short circuit in the cell or the wires that connect the cell to contact points on the battery pack. Tiny metal shards can contaminate the battery pack during assembly and later pierce the insulation separating the positive and negative terminals. The opposite poles touch and create an electrical spark. A defective or damaged battery that is vigorously jostled, like a laptop rattling around in a luggage compartment, can trigger a flare.

The Consumer Product Safety Commission has documented hundreds cases of lithium and lithium-ion batteries for portable electronics overheating, emitting smoke and fumes or exploding since 2003, and the Federal Aviation Administration has logged 60 incidents since 1991. In the past two years, six incidents have occurred on aircraft, including five fires and an overheated flashlight that had to be handled with oven mitts. Such hazards have prompted dozens of manufacturers to recall more than two million rechargeable batteries for cellphones, laptops, portable DVD players and digital cameras since 2003. Major U.S. computer makers Hewlett-Packard Co., Apple Computer Inc. and Dell Inc. each cited reports of overheating and fire risk as reasons for recalling a total of 300,700 units of laptop batteries world-wide since May of 2005. “The affected batteries could overheat, posing a fire hazard to consumers,” said an Apple statement posted on its Web site detailing a program in which consumers can exchange their recalled batteries for new ones.

A series of fires dating back to 1999 led to a federal regulation in 2004 banning cargo shipments of non-rechargeable lithium batteries from the bellies of passenger aircraft. The rule called lithium batteries on commercial airliners “an immediate safety risk” but did not prohibit them from carry-on or checked luggage. Today, the more-advanced lithium-ion batteries account for the majority of battery incidents. Many of the airplane incidents involve batteries purchased separately from the computer. Reputable manufacturers typically submit to testing and safety standards set by groups such as the non-profit Underwriters Laboratories. These standards require that batteries contain built-in protections against overheating and fire; however, these protections are not required by law and some manufacturers simply ignore them. There are currently no controls on such batteries in carry-on luggage or checked bags or when shipped in the cargo holds of passenger planes. Thus, there is an ongoing need for a system that provides significant protection against fire or explosion when lithium, lithium-ion, or other potentially hazardous batteries are carried onto aircraft, particularly commercial aircraft.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a storage system is provided. This storage system includes at least one electronic device, wherein the at least one electronic device further includes at least one battery that is prone to fire or explosion under predetermined environmental conditions; and at least one container for storing the at least one electronic device. The at least one container further includes a body having an open end and at least one cavity formed therein, wherein the at least one cavity is adapted to receive the electronics device; and at least one flap for covering the open end of the body, wherein the at least one flap is adjustable for accommodating electronic devices of different types and sizes a and shapes. The body and the flap are manufactured from at least one fire-resistant material.

In accordance with another aspect of the present invention, a container for electronics equipment is provided. This container includes a body having an open end and at least one cavity formed therein, wherein the at least one cavity is adapted to receive electronics equipment; and at least one flap for covering the open end of the body, wherein the at least one flap is adjustable for accommodating electronics equipment of different types and sizes. The body and the at least one flap are manufactured from at least one fire-resistant material.

In yet another aspect of this invention, a container for battery-operated electronics equipment is provided. This container includes a body having an open end and further defining at least one cavity therein, wherein the at least one cavity is adapted to receive electronics equipment, and wherein the electronics equipment further includes at least one battery that is prone to fire or explosion under predetermined environmental conditions; and at least one flap for covering the open end of the body, wherein the at least one flap is adjustable for accommodating electronics equipment of different types and sizes. The body and the at least one flap are manufactured from at least one fire-resistant material and the container is operative to substantially contain a fire or explosion in the event that the battery catches fire or explodes.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 depicts a first exemplary embodiment of the fire resistant container of the present invention shown configured for a cell or mobile phone

FIG. 2 depicts a second exemplary embodiment of the fire resistant container of the present invention shown configured for a laptop or notebook computer.

FIGS. 3a-b depict a third exemplary embodiment of the fire resistant container of the present invention configured to include a VELCRO® strap closure.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to “fireproof”, fire-resistant, and or flame-retardant containers, and more specifically to flexible, fire-resistant containers for use with electronics equipment that includes one or more lithium batteries, particularly re-chargeable lithium-ion batteries and the like. As previously indicated, a first general embodiment of this invention provides a storage system; a second general embodiment of this invention provides a container for electronics equipment; and a third general embodiment of this invention provides a container for battery-operated electronics equipment. With reference now to the Figures, one or more specific embodiments of this invention shall be described in greater detail.

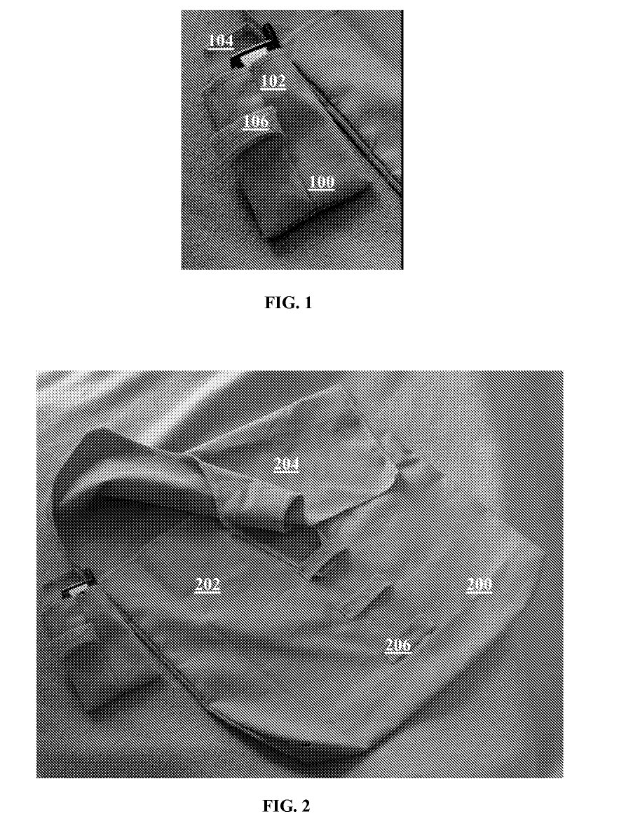

With reference now to the FIGS. 1 and 2, two separate exemplary embodiments of the present invention are shown. The exemplary embodiment shown in FIG. 1 is intended for use with a small electronic device such as mobile phones, PDAs, or other similar devices. The exemplary embodiment shown in FIG. 2 is intended for use with larger electronic devices such as laptop or notebook computers or other similar devices. Although two embodiments are shown in FIGS. 1-2, it will appreciated by the skilled artisan that numerous shapes and sizes are possible, and that the general configuration of the present invention is not limited to the versions/configurations shown in FIGS. 1 and 2.

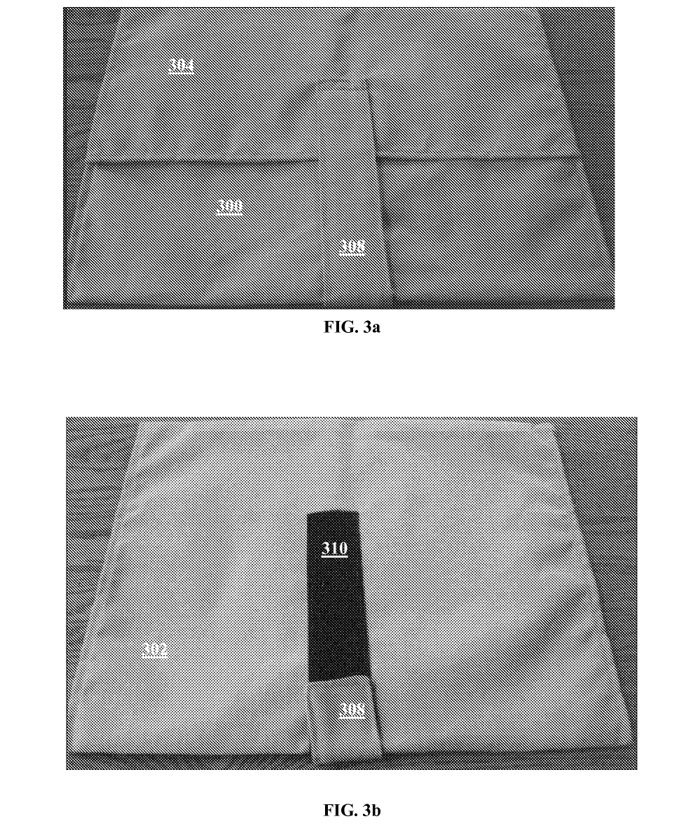

The embodiment of container 100 shown in FIG. 1 includes body portion 102, flap 104, and strap 106. The embodiment of container 200 shown in FIG. 2 includes body portion 202, flap 204, and straps 206. Both embodiments are essentially a container, sack, or bag that has been specifically modified and configured to hold or contain one or more electronic devices that are powered by rechargeable lithium, lithium-ion or other types of batteries that may be prone to fire or explosion. Body portions 102 and 202 both include an open end and a cavity formed therein for receiving and storing electronics equipment. Moveable flaps 104 and 204 cover the open end of body portions 102 and 202 respectively and each flap is adjustable for accommodating electronics equipment of different types, sizes, and shapes. Any of a variety of closure devices, such as straps 106 and 206, may be included on different embodiments of this invention. In the exemplary embodiments shown in FIGS. 1-2, straps 106 and 206 are adapted to receive a portion of flaps 104 and 204 respectively. In other embodiments, heat resistant snaps or other closure means are provided with the invention. In the exemplary embodiment shown in FIGS. 3a-b, the straps (106 and 206) have been replaced by a VELCRO® strip 310, which is sewn or otherwise attached to body 302, and which receives a corresponding portion of strap 308, which has been sewn or otherwise attached to flap 304 of container 300. The body portions, flaps, and straps are manufactured from at least one fire-resistant material. A variety of commercially available fireproof, fire resistant, or flame retardant materials such as those containing aramid fibers are suitable for use with and incorporation into the present invention. Such commonly known materials include KEVLAR®, BASOFIL®, NOMEX®, TECHNORA®, or combinations thereof.

When in use, the present invention safely stores an electronic device that utilizes a potentially hazardous battery that may present an in-flight fire or explosion risk when carried aboard an aircraft. The user of this invention simply places the electronic equipment into the container and secures the container in a closed position. Once secured in this manner, the user of this invention then places the container in an overhead storage compartment or under a seat. If a battery overheats, catches fire, or even explodes, the container will substantially prevent the fire from spreading to the areas adjacent to the stored device. Thus, the present invention greatly reduces the obvious risks associated with transporting electronic devices with potentially hazardous batteries aboard aircraft or other vehicles.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A storage system, comprising:
(a) at least one electronic device, wherein the at least one electronic device further includes at least one battery that is prone to fire or explosion under predetermined environmental conditions; and
(b) at least one container for storing the at least one electronic device, wherein the at least one container further includes:
(i) a body having an open end and at least one cavity formed therein, wherein the at least one cavity is adapted to receive the electronics device;
(ii) at least one flap for covering the open end of the body, wherein the at least one flap is adjustable for accommodating electronic devices of different types and sizes and shapes; and
(iii) wherein the body and the flap are manufactured from at least one fire-resistant material.

2. The system of claim 1, wherein the at least one electronic device is a laptop computer.

3. The system of claim 1, wherein the at least one battery is a lithium battery or a lithium-ion battery.

4. The system of claim 1, wherein the at least one container further container fastening means for securing the at least one flap to the at least one body.

5. The system of claim 1, wherein the at least one fire resistant material further comprises aramid fibers.

6. The system of claim 1, wherein the at least one fire resistant material further comprises KEVLAR®, BASOFIL®, NOMEX®, TECHNORA® or combinations thereof.

7. A container for electronics equipment, comprising:
(a) a body having an open end and at least one cavity formed therein, wherein the at least one cavity is adapted to receive electronics equipment;
(b) at least one flap for covering the open end of the body, wherein the at least one flap is adjustable for accommodating electronics equipment of different types and sizes; and
(c) wherein the body and the at least one flap are manufactured from at least one fire-resistant material.

8. The container of claim 7, wherein the electronics equipment is a laptop computer or a notebook computer.

9. The container of claim 7, wherein the electronics equipment further comprises at least one battery, and wherein the at least one battery is a lithium battery or a lithium-ion battery.

10. The container of claim 7, wherein the container further comprises fastening means for securing the at least one flap to the at least one body.

11. The container of claim 10, wherein the fastening means further comprises at least one strap mounted on the body, wherein the strap is adapted to receive a portion of the flap.

12. The container of claim 7, wherein the at least one fire resistant material further comprises aramid fibers.

13. The container of claim 7, wherein the at least one fire resistant material further comprises KEVLAR®, BASOFIL®, NOMEX®, TECHNORA® or combinations thereof.

14. A container for battery-operated electronics equipment, comprising:
(a) a body having an open end and at least one cavity formed therein, wherein the at least one cavity is adapted to receive electronics equipment, and wherein the electronics equipment further includes at least one battery that is prone to fire or explosion under predetermined environmental conditions;
(b) at least one flap for covering the open end of the body, wherein the at least one flap is adjustable for accommodating electronics equipment of different types and sizes; and
(c) wherein the body and the at least one flap are manufactured from at least one fire-resistant material; and
(d) wherein the container is operative to substantially contain a fire or explosion in the event that the battery catches fire or explodes.

15. The container of claim 14, wherein the electronics equipment is a laptop computer or a notebook computer.

16. The container of claim 14, wherein the at least one battery further comprises a lithium battery or a lithium-ion battery.

17. The container of claim 14, wherein the container further comprises fastening means for securing the at least one flap to the at least one body.

18. The container of claim 17, wherein the fastening means further comprises at least one strap mounted on the body, wherein the strap is adapted to receive a portion of the flap.

19. The container of claim 14, wherein the at least one fire resistant material further comprises aramid fibers.

20. The container of claim 14, wherein the at least one fire resistant material further comprises KEVLAR®, BASOFIL®, NOMEX®, TECHNORA®, or combinations thereof.
